(19) United States
(12) Patent Application Publication
(10) Pub. No.: US 2025/0093817 A1
(43) Pub. Date: Mar. 20, 2025

(54) SMARTWATCH

(71) Applicant: Huawei Technologies Co., Ltd., Shenzhen (CN)

(72) Inventors: Shifeng Fu, Xi’an (CN); Xiaogang Liu, Xi’an (CN); Fanyue Meng, Xi’an (CN)

(21) Appl. No.: 18/966,626

(22) Filed: Dec. 3, 2024

Related U.S. Application Data
(63) Continuation of application No. PCT/CN2023/100490, filed on Jun. 15, 2023.

(30) Foreign Application Priority Data
Jun. 22, 2022 (CN) 202221590061.4

(51) Int. Cl. G04B 3/04; G04G 17/04

(52) U.S. Cl. CPC G04B 3/046; G04G 17/04

(57) ABSTRACT

A smartwatch, including: a watch frame, a watch core is disposed in the watch frame; and a button, including a button cap, a first button lever and a second button lever, where the button cap is connected to the first button lever, the first button lever is disposed in a button hole provided on the watch frame, and the second button lever is disposed in a button hole opposite to the first button hole provided on the watch core. When the button is in a working state, the first button lever and the second button lever are engaged with each other, and the second button lever can transfer pressure or torque from the button cap. When the button is in a detached state, the first button lever and the second button lever are separated from each other, and the watch core can be taken out of the watch frame.

### CROSS-REFERENCE TO RELATED APPLICATIONS

This application is a continuation of International Application No. PCT/CN2023/100490, filed on Jun. 15, 2023, which claims priority to Chinese Patent Application No. 202221590061.4, filed on Jun. 22, 2022. The disclosures of the aforementioned applications are hereby incorporated by reference in their entireties.

### TECHNICAL FIELD

This application relates to the field of intelligent wearable device technologies, and in particular, to a smartwatch.

### BACKGROUND

With rapid improvement of informatization and people's requirements for portable and intelligent wearable devices such as a smartwatch, miniaturization, lightweight, a high screen-to-body ratio, and high interaction are future development directions of the smartwatch, for example, application of a rotating button in a high interaction requirement. For a conventional smartwatch, a button lever of a button extends into the watch from a mounting hole on a watch frame and is connected to a watch core. The connection between the button lever and the watch core is usually a non-detachable connection. Due to a blocking function of the button lever, the watch frame and the watch core of the conventional smartwatch form an integrated design structure, and a common user cannot detach the watch core from the watch frame. With rapid iteration of wearable products, the conventional design cannot meet a requirement of a user for a differentiated and personalized form of product appearance. A smartwatch in which a watch core can be detached from a watch frame is urgently needed, so that the same watch core can be used with a plurality of watch frames of different colors or styles.

### SUMMARY

This application provides a smartwatch. A structure of the button is improved, so that the watch core can be detached from the watch frame. In this way, the same watch core can be used with a plurality of watch frames of different colors or styles.

According to a first aspect, a smartwatch is provided, including:
a watch frame, where a first button hole is provided on the watch frame, a watch core is disposed in the watch frame, and a second button hole opposite to the first button hole is provided on the watch core;
a button, including a button cap, a first button lever, and a second button lever, where the button cap is connected to the first button lever, the first button lever is disposed in the first button hole, and the second button lever is disposed in the second button hole, where
the button may enter a working state or a detached state by adjusting a position of the first button lever by using the button cap; and when the button is in the working state, the first button lever and the second button lever are engaged with each other, and the second button lever can transfer pressure or torque from the button cap; or when the button is in the detached state, the first button lever and the second button lever are separated from each other, and the watch core can be taken out of the watch frame.

In a possible design, when the button is in the working state, the first button lever and the second button lever are plug-connected and cooperate with each other.

In a possible design, when the button is in the working state, an end face of the first button lever abuts against an end face of the second button lever to generate a friction force, and the torque is transferred by using the friction force.

In a possible design, the smartwatch further includes magnetic components, and the magnetic components are configured to generate a magnetic attraction force to increase pressure between the end face of the first button lever and the end face of the second button lever.

In a possible design, the smartwatch further includes:
a crown tube, where the crown tube is sleeved on a periphery of the first button lever, and an inner end is fixedly inserted into the first button hole, where
the first button lever includes a first lever body and a connecting block, one end of the first lever body is fastened to the button cap, the other end of the first lever body is fixedly sleeved with the connecting block, and the connecting block slides and penetrates through the inner end of the crown tube.

In a possible design, a positioning plug is disposed on an end face of the connecting block, and a second positioning slot for the positioning plug to be inserted into is disposed on the end face of the second button lever.

In a possible design, a first positioning slot is disposed on an end face of the connecting block, and the first button lever further includes a first magnetic component that is located in the first positioning slot;
the second button lever includes a second lever body and a second magnetic component, and the second magnetic component is disposed in a second positioning slot that is disposed on an end face of the second lever body; and
there is a magnetic attraction force between the first magnetic component and the second magnetic component, and when the button is in the working state, the first magnetic component and the second magnetic component are attached to each other.

In a possible design, the smartwatch further includes:
a spring bar holder, fastened to an inside of the crown tube and sleeved on a periphery of the first lever body; and
a spring bar, disposed on the spring bar holder, where the spring bar is configured to provide an elastic clamping force for the first lever body.

In a possible design, the smartwatch further includes:
a spring and a gasket, both sleeved on the first lever body and clamped between the connecting block and the spring bar holder, where the spring is configured to provide an elastic force for the connecting block through the gasket, to keep the button in the working state.

In a possible design, the second button lever is embedded into the second button hole by using an elastic rubber ring, and the elastic rubber ring is sleeved on a periphery of the second button lever and is located in a positioning ring slot.

In a possible design, the watch core includes:
a mounting holder;
a button switch, mounted on the mounting holder and configured to be pressed by the second button lever, where the button switch includes an elastomer configured to reset the second button lever; and
a rotation detection sensor, mounted on the mounting holder and configured to detect a rotation angle of the second button lever.

In a possible design, a fastening slot with an internal thread is provided on a rear end face of the connecting block, and the connecting block is fastened to the first lever body through the fastening slot.

In a possible design, the spring bar holder is of a disk-shaped structure and is connected to the inside of the crown tube through a thread, and the spring bar and the spring are located on two opposite sides of the spring bar holder.

In a possible design, the crown tube is fastened in the first button hole through bonding, screwing, welding, or riveting.

In a possible design, the watch core includes a display and a watch core case, the display is fastened on the watch core case, and the second button hole is provided on the watch core case. In this case, the watch core can be taken out and independently used as a pocket watch.

According to the smartwatch provided in this embodiment of this application, a button lever of the button includes two independent parts. To be specific, the button includes the first button lever and the second button lever. The first button lever is disposed in the first button hole on the watch frame, and the second button lever is disposed in the second button hole on the watch core. The first button lever and the second button lever can be engaged with each other, so that the button enters the working state. Alternatively, the first button lever and the second button lever may be separated from each other, so that the button enters the detached state.

A user may adjust the position of the first button lever by using the button cap, so that the button enters the working state or the detached state. For example, the user may press the button cap to enable the first button lever retracted into the watch, so that the first button lever and the second button lever are engaged (butted) with each other, and the second button lever can transfer the pressure or the torque from the button cap. In this case, the button enters the working state and can normally perform adjustment, and the user may adjust the smartwatch by rotating or pressing the button.

The button provided in this embodiment of this application further has the detached state. The user may pull the first button lever outward the watch by using the button cap, so that the button enters the detached state. In other words, the button in this application can implement three actions: pressing, rotating, and pulling. When the user pulls the first button lever outward by using the button cap, the first button lever and the second button lever are separated from each other, the gap is generated between the first button lever and the second button lever, and the watch core and the watch frame are independent of each other. In this case, the user can take the watch core out of the watch frame, so that the same watch core can be used with a plurality of watch frames of different colors or styles. Therefore, the smartwatch provides relatively good user experience, and this can facilitate maintenance and repair on the smartwatch.

The smartwatch provided in this embodiment of this application may have the plurality of watch frames. The colors or styles of the plurality of watch frames may be different. An additional watch frame may be sold together as an accessory of the smartwatch, or may be independently selected and purchased by the user. The user can conveniently and efficiently detach the watch core from the watch frame and mount the watch core into another watch frame by using the structure of the button. The user may use the watch core with different watch frames based on an actual scenario, so that a requirement of the user for a differentiated and personalized product appearance form can be met. Therefore, the smartwatch provided in this embodiment of this application is more competitive in a market.

### BRIEF DESCRIPTION OF THE DRAWINGS

FIG. 1 is a diagram of a structure of a smartwatch according to an embodiment of this application;

FIG. 2 is a sectional view of a smartwatch according to an embodiment of this application;

FIG. 3 is an exploded view of a partial structure of a smartwatch according to an embodiment of this application;

FIG. 4 is a diagram of a connection structure of a button of a smartwatch according to an embodiment of this application;

FIG. 5 is a partial enlarged view of a button part in FIG. 2;

FIG. 6 is a diagram of an assembling structure of an example of a button of a smartwatch according to an embodiment of this application;

FIG. 7 is an exploded view of the structure shown in FIG. 6;

FIG. 8 is a diagram of an assembling structure of another example of a button of a smartwatch according to an embodiment of this application;

FIG. 9 is an exploded view of the structure shown in FIG. 8;

FIG. 10 is a diagram of an assembling structure of still another example of a button of a smartwatch according to an embodiment of this application;

FIG. 11 is an exploded view of the structure shown in FIG. 10;

FIG. 12 is a diagram of an assembling structure of still another example of a button of a smartwatch according to an embodiment of this application;

FIG. 13 is an exploded view of the structure shown in FIG. 12;

FIG. 14 is a diagram of an assembling structure of still another example of a button of a smartwatch according to an embodiment of this application; and

FIG. 15 is an exploded view of the structure shown in FIG. 14.

### REFERENCE NUMERALS

100: housing; 110: watch frame; 111: first button hole; 120: rear cover;
200: watch core; 210: second button hole; 220: mounting holder; 230: button switch; 240: rotation detection sensor; 250: watch core case;
300: button; 310: button cap; 320: first button lever; 321: first lever body; 322: connecting block; 322a: positioning plug; 322b: fastening slot; 322c: first positioning slot; 323: first magnetic component; 330: second button lever; 331: second lever body; 331a: second positioning slot; 331b: positioning ring slot; 331c: elastic rubber ring; 331d: positioning convex ring; 332: second magnetic component; 340: hex nut;
400: crown tube; 410: spring bar; 420: spring bar holder; 430: spring; 440: gasket;
500: display.

### DETAILED DESCRIPTION OF ILLUSTRATIVE EMBODIMENTS

The following describes implementations of this application in detail. Examples of the implementations are shown in the accompanying drawings. Same or similar reference signs are always used to represent same or similar elements or elements having same or similar functions. The implementations described below with reference to the accompanying drawings are examples, and are merely used to explain this application, but cannot be understood as a limitation on this application.

In descriptions of this application, it should be noted that, unless otherwise clearly specified and limited, terms “mount” and “connection” should be understood in a broad sense, for example, may be a fixed connection, a detachable connection, or integrated connection; may be a mechanical connection, an electrical connection, or mutual communication; or may be a direct connection, an indirect connection through an intermediate medium, communication inside two elements, or an interaction relationship between two elements. A person of ordinary skill in the art may understand specific meanings of the terms in this application based on specific cases.

In the descriptions of this application, it should be understood that an orientation or a position relationship indicated by terms such as “on”, “below”, “side”, “front”, and “rear” is based on orientation or a position relationship of mounting, and is merely intended for ease of describing this application and simplifying description, but does not indicate or imply that a described apparatus or element needs to have a specific orientation or be constructed or operated in a specific orientation. Therefore, such terms should not be understood as a limitation on this application.

It should be further noted that a same reference numeral in embodiments of this application indicates a same component or a same part. For same parts in embodiments of this application, only one part or component marked with a reference numeral may be used as an example in the figure. It should be understood that the reference numeral is also applicable to another same part or component.

With development of science and technology, wearable electronic products such as a smartwatch are rapidly popularized. This greatly promotes development of society and facilitates people's life. The smartwatch is a watch that has an information processing capability and meets a basic technical requirement of a watch. In addition to indicating time, the smartwatch usually further has one or more functions of reminding, navigating, calibrating, monitoring, interacting, or the like. A display manner includes a pointer, a number, an image, and the like. The smartwatch may be classified, based on different user groups, into several categories such as a smartwatch for adults, a smartwatch for seniors, and a smartwatch for kids.

The smartwatch for adults usually includes one or more of the following functions: synchronized phone calling through Bluetooth, SMS message sending and receiving, sleep monitoring, heart rate monitoring, activity reminding, step counting when running, remote photographing, music playing, video recording, a compass, and the like.

In recent years, to meet use requirements of different people, the smartwatch for adults may be further classified into a smartwatch for male adults and a smartwatch for female adults. Further, the smartwatch for female adults may be further classified into a smartwatch for pregnant women or a smartwatch for women who prepare for pregnancy.

The smartwatch for seniors usually includes one or more of the following functions: ultra-accurate global positioning system (global positioning system, GPS) positioning, family calling, emergency calling, heart rate monitoring, activity reminding, medicine taking reminding, and other functions that are specifically customized for elderly people.

The smartwatch for kids usually includes one or more of the following functions: multi-system positioning, two-way calling, SOS calling, remote monitoring, intelligent loss prevention, historical track, electronic fence, a pedometer, love rewarding, and the like. Similarly, the smartwatch for kids may also be further classified for children of different ages.

In recent years, users have an increasingly high use requirement for the smartwatch, not only require perfect use experience of the watch, but also require exquisite appearance and texture. As a result, an increasingly high requirement is imposed on a design of the watch. Miniaturization, lightweight, a high screen-to-body ratio, and high interaction are future development directions of the smartwatch, for example, application of a rotating button in a high interaction requirement.

A button, also referred to as a crown or a button, is usually disposed on a side of a watch face. The button is connected to an inside of the watch face, and can be configured to adjust time, perform switching on/off, adjust a speaker playing volume, adjust brightness of a display, and the like. The button can be rotated or pressed, to implement the foregoing functions.

For a conventional smartwatch, a button lever of the button extends into the watch from a mounting hole on a watch frame (also referred to as a middle frame or a frame) and is connected to a watch core. A connection between the button lever and the watch core is usually a non-detachable connection. Under a connecting blocking function of the button lever, the watch frame and the watch core of the conventional smartwatch form an integrated design structure, and a common user cannot detach the watch core from the watch frame. With rapid iteration of wearable products, the conventional design cannot meet a requirement of the user for a differentiated and personalized form of product appearance. A smartwatch in which the watch core can be detached from the watch frame is urgently needed, so that the same watch core can be used with a plurality of watch frames of different colors or styles.

In view of this, embodiments of this application provides a smartwatch. A structure of the button is improved, so that the watch core can be detached from the watch frame, and the same watch core can be used with the plurality of watch frames of different colors or styles. Therefore, the smartwatch provides relatively good user experience, and this can facilitate maintenance and repair on the smartwatch.

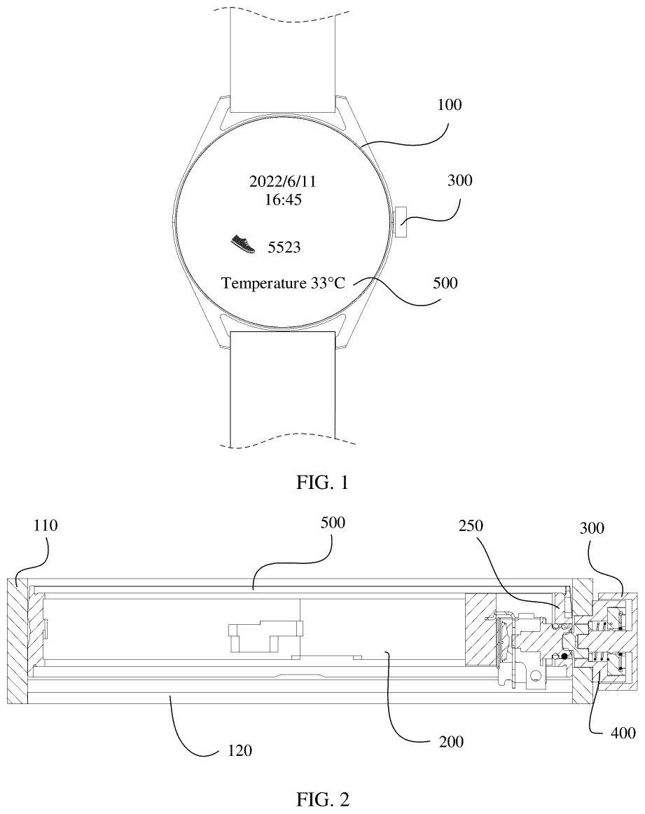

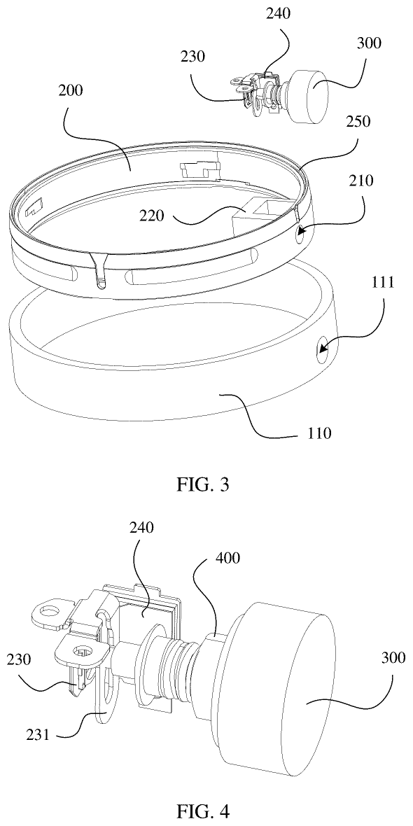

FIG. 1 is a diagram of a structure of a smartwatch according to an embodiment of this application. FIG. 2 is a sectional view of a smartwatch according to an embodiment of this application. FIG. 3 is an exploded view of a partial structure of a smartwatch according to an embodiment of this application.

As shown in FIG. 1 to FIG. 3, the smartwatch provided in an embodiment of this application may be any one of the foregoing smartwatch for adults (for example, a smartwatch for male adults, a smartwatch for female adults, a smartwatch for pregnant women, and a smartwatch for women who prepare for pregnancy), the smartwatch for seniors, the smartwatch for kids, and the like. In addition, the smartwatch 100 may also be a smartwatch for special operations such as a diving watch used by a diver.

It should be noted that the smartwatch provided in this embodiment of this application should further include another wrist-worn wearable device such as a smart band, and even include an intelligent wearable device for another body part such as an ankle or a neck. Therefore, the “smartwatch” in embodiments of this application should not be limited, although referred to as the “smartwatch”, to a “watch”, and may be another electronic device, for example, may be another intelligent wearable device. In some cases, the smartwatch may alternatively be a mechanical watch or a pocket watch.

As shown in FIG. 1, the smartwatch provided in this embodiment of this application includes a watch face and a watch strap (only a part of the watch strap is shown). The watch face may also be referred to as a watch head, and is a body part of the watch. The watch strap usually includes two parts that are respectively connected to two opposite sides of the watch face. The two parts are used together, so that the smartwatch is worn on a wrist of a user.

As shown in FIG. 1 to FIG. 3, the watch face includes a housing 100 and a display 500, and the housing 100 includes a watch frame 110 and a rear cover 120. The watch frame 110 is of a hollow ring-shaped structure, the display 500 is fastened to a front end of the watch frame 110, and the rear cover 120 is fastened to a rear end of the watch frame 110. The display 500, the watch frame 110, and the rear cover 120 together define an inner cavity of the smartwatch. The inner cavity is configured to accommodate electronic components such as a speaker, a mainboard, a camera, a microphone, a sensor, a memory, a processor, and a battery.

The watch frame 110 provides mechanical support and protection for the entire smartwatch. The watch frame 110 is made of a material with sufficient hardness. The material of which the watch frame 110 is made may be, for example, stainless steel, ceramic, titanium alloy, aluminum alloy, copper alloy, or hard plastic. As shown in FIG. 1 and FIG. 3, in this embodiment of this application, a cross-sectional shape of the watch frame 110 (corresponding to shapes of the display 500 and the rear cover 120) is a circle. In another implementation, the cross-sectional shape of the watch frame 110 may alternatively be a rectangle, a square, a runway, an ellipse, or the like.

The rear cover 120 covers the bottom end of the watch frame 110, and is in contact with the wrist of the user when the smartwatch is worn. The rear cover 120 and the watch frame 110 are connected in a sealed manner, so that waterproof effect is achieved.

Optionally, the rear cover 120 may be a stainless steel rear cover, a titanium alloy rear cover, a glass rear cover, a ceramic rear cover, an aluminum alloy rear cover, a copper alloy rear cover, a plastic rear cover, or the like.

Optionally, the rear cover 120 may cover the watch frame 110 through screwing, snap-fitting, or the like. A sealing ring may be disposed between the rear cover 120 and the watch frame 110, to improve sealing and waterproof effect at a joint between the rear cover 120 and the watch frame 110. The sealing ring may be made of a material with high elasticity such as silicone or rubber.

Optionally, the rear cover 120 and the watch frame 110 may be made into an integrated structure through an integrated molding process, so that the structure of the watch can be simplified, and production efficiency can be improved. In addition, there is no joint gap between the rear cover 120 and the watch frame 110, so that overall waterproof effect of the watch can be further improved.

For example, the integrated molding process may be casting, sintering, injection molding, a 3D printing technology, or the like, but is not limited thereto.

The display 500 is configured to: provide human-machine interaction between the user and the smartwatch, for example, display information (for example, information about time, news, weather, or the like) to the user or receive information input by the user (for example, receive a control instruction of the user).

Optionally, the display 500 may be a touchscreen, for example, may be a liquid crystal display (LCD), an organic light-emitting diode (OLED), an active-matrix organic light emitting diode (AMOLED), a flexible light-emitting diode (FLED), a mini-LED, a micro-LED, a micro-OLED, or a quantum dot light emitting diode (QLED) display, but is not limited thereto.

The display 500 is fixedly mounted on the housing 100, to form an accommodating cavity (namely, an inner cavity of the watch) that is configured to accommodate a watch core 200. The watch core 200 is a body part of the smartwatch, and the watch core 200 may be formed by integrating a plurality of electronic components. A specific composition of the watch core 200 is not specifically limited in this embodiment of this application. For example, the watch core 200 may be formed by combining any one or more components in the smartwatch. The watch core 200 shown in FIG. 2 and FIG. 3 is merely used as an example. For example, during actual application, the watch core 200 may be of a solid disk structure formed by integrating a plurality of components rather than a hollow structure in the figure.

As shown in FIG. 1 to FIG. 3, the smartwatch provided in this embodiment of this application further includes a button 300 disposed on an outer wall of the watch frame 110. The button 300 is connected to the internal watch core 200, and can be configured to perform function adjustment on the smartwatch, for example, can be configured to adjust time, perform switching on/off, adjust a speaker playing volume, adjust brightness of a display, and the like. The button 300 can be rotated or pressed, to implement each of the foregoing functions.

As shown in FIG. 2 and FIG. 3, the button 300 penetrates into an inside of the smartwatch from an outside of the smartwatch, and is connected to the watch core 200, so that the foregoing adjustment function can be implemented. The watch core 200 is fastened in the watch frame 110, a first button hole 111 is provided on the watch frame 110, a second button hole 210 opposite to the first button hole 111 is provided on the watch core 200, and the two button holes are configured to be inserted by a button lever of the button 300.

Embodiments of this application mainly relate to improvement performed on a structure of the button 300, and provide a new button design solution, so that the watch core 200 can be detached from the watch frame 110, and the same watch core 200 can be used with a plurality of watch frames 110 of different colors or styles. Therefore, the smartwatch provides relatively good user experience, and this can facilitate maintenance and repair on the smartwatch.

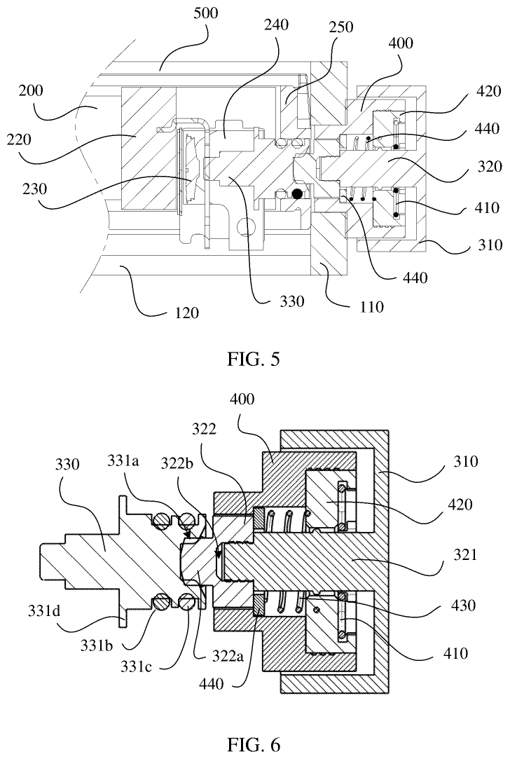

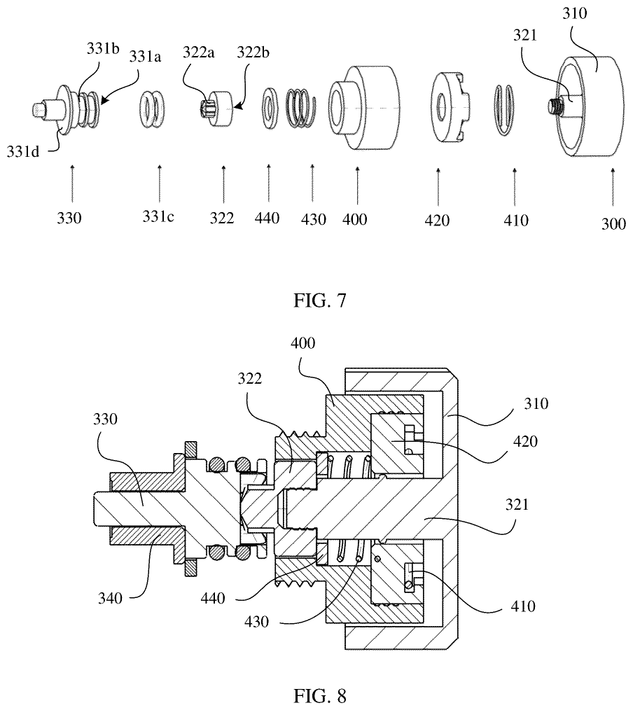

FIG. 4 is a diagram of a connection structure of a button 300 of a smartwatch according to an embodiment of this application. FIG. 5 is a partial enlarged view of a button part in FIG. 2. FIG. 6 is a diagram of an assembling structure of an example of a button 300 of a smartwatch according to an embodiment of this application. FIG. 7 is an exploded view of the structure shown in FIG. 6.

As shown in FIG. 4 to FIG. 7, in this embodiment of this application, the button 300 includes a button cap 310, a first button lever 320, and a second button lever 330. The button cap 310 is fastened to the first button lever 320, the first button lever 320 is disposed in the first button hole 111, and the second button lever 330 is disposed in the second button hole 210.

The button 300 may enter a working state or a detached state by adjusting a position of the first button lever 320 by using the button cap 310. When the button 300 is in the working state, the first button lever 320 and the second button lever 330 are engaged (butted) with each other, and the second button lever 330 can transfer pressure or torque from the button cap 310. When the button 300 is in the detached state, the first button lever 320 and the second button lever 330 are separated from each other. In this case, a gap is generated between the first button lever 320 and the second button lever 330, and the watch core 200 can be taken out of the watch frame 110.

According to the smartwatch provided in this embodiment of this application, a button lever of the button 300 includes two independent parts. To be specific, the button 300 includes the first button lever 320 and the second button lever 330. The first button lever 320 is disposed in the first button hole 111 on the watch frame 110, and the second button lever 330 is disposed in the second button hole 210 on the watch core 200. The first button lever 320 and the second button lever 330 can be engaged with each other, so that the button 300 enters the working state. Alternatively, the first button lever 320 and the second button lever 330 may be separated from each other, so that the button 300 enters the detached state.

A user may adjust the position of the first button lever 320 by using the button cap 310, so that the button 300 enters the working state or the detached state. For example, the user may press the button cap 310 to enable the first button lever 320 retracted into the watch, so that the first button lever 320 and the second button lever 330 are engaged (butted) with each other, and the second button lever 330 can transfer the pressure or the torque from the button cap 310. In this case, the button 300 enters the working state and can normally perform adjustment, and the user may adjust the smartwatch by rotating or pressing the button 300.

The button 300 provided in this embodiment of this application further has the detached state. The user may pull the first button lever 320 outward the watch by using the button cap 310, so that the button 300 enters the detached state. In other words, the button 300 in this application can implement three actions: pressing, rotating, and pulling. When the user pulls the first button lever 320 outward by using the button cap 310, the first button lever 320 and the second button lever 330 are separated from each other, the gap is generated between the first button lever 320 and the second button lever 330, the first button lever 320 and the second button lever 330 are no longer in contact, and the watch core 200 and the watch frame 111 are independent of each other. In this case, the button lever no longer constitutes an obstacle, the user can take the watch core 200 out of the watch frame 110, and the same watch core 200 can be used with a plurality of watch frames 111 of different colors or styles. Therefore, the smartwatch provides relatively good user experience, and this can facilitate maintenance and repair on the smartwatch.

The smartwatch provided in this embodiment of this application may have the plurality of watch frames 111. The colors or styles of the plurality of watch frames 111 may be different. An additional watch frame 111 may be sold together as an accessory of the smartwatch, or may be independently selected and purchased by the user. The user can conveniently and efficiently detach the watch core 200 from the watch frame 111 and mount the watch core 200 into another watch frame 111 by using the structure of the button 300. The user may use the watch core 200 with different watch frames 111 based on an actual scenario, so that a requirement of the user for a differentiated and personalized product appearance form can be met. Therefore, the smartwatch provided in this embodiment of this application is more competitive in a market.

It should be noted that, when the button 300 enters the detached state, the first button lever 320 and the second button lever 330 are separated from each other and independent of each other. In this case, the watch core 200 can be taken out of the watch frame 110. To achieve this objective, an inner end of the first button lever 320 should not extend into the second button hole 210, and an outer end of the second button lever 330 should not extend into the first button hole 111.

In a possible implementation, the watch core 200 includes a watch core case 250 and the foregoing display 500. The display 500 fixedly covers an opening of the watch core case 250, and an integrated structure is formed. A plurality of electronic components such as a mainboard, a battery, and a speaker are all disposed inside the integrated structure. The second button hole 210 is disposed on the watch core case 250. In this case, a housing 100 is equivalent to a watch holder that can accommodate the watch core 200. When the watch core 200 is taken out of the housing 100, the watch core 200 is similar to a pocket watch in a conventional sense. Therefore, the watch core 200 can be independently used, and the user can put the watch core 200 in a pocket or hang the watch core 200 on a neck by using a string, so that a personalized use requirement of the user is met.

As shown in FIG. 3 to FIG. 5, the watch core 200 further includes a mounting holder 220, a button switch 230, and a rotation detection sensor 240 that are located in the watch core case 250. The mounting holder 220 is fixedly mounted in the watch core case 250. The button switch 230 is mounted on the mounting holder 220, and is configured to be pressed by an inner end of the second button lever 330. The button switch 230 includes an elastomer 231 configured to reset the second button lever 330. The end of the second button lever 330 squeezes the elastomer 231, and further triggers the button switch 230 to send a corresponding signal, so that a button function is implemented. The rotation detection sensor 240 is mounted on the mounting holder 220, and is configured to detect a rotation angle of the second button lever 330.

Herein, the button switch 230 is configured to detect a pressing action of the user. The button switch 230 may be mounted on the mounting holder 220 through dispensing, a positioning hole and adhesive backing, a snap-fit, or the like, and faces the second button lever 330, so that the button switch 230 is triggered by the second button lever 330 to be turned on after the second button lever 330 is pressed. There is the elastomer 231 on the button switch 230. The elastomer 231 is fixedly mounted on the mounting holder 220 by using a heat stake, and limits the elastomer 231 by using the heat stake.

In a mounting process, the elastomer 231 is in interference fit with the second button lever 330 by a guide angle. In an unpressed state, the elastomer 231 has an initial magnitude of interference that represents an initial rebound force of the button 300. The rebound force cannot be excessively large, which may cause a feeling of being relatively hard to press, nor excessively small, which may cause, in a pressing process, a risk of idle stroke or a risk that the second button lever 330 does not rebound. In the pressing process, an elastic force of the button 300 is provided by the elastomer 231. The elastomer 231 does not generate plastic deformation under a specific quantity of pressing times.

In addition, the elastomer 231 abuts against the inner end of the second button lever 330. When the button 300 is rotated, a feeling of damping can be provided for the user. In addition, in a rotation process, friction between the elastomer 231 and the second button lever 330 is symmetric, and consistency between a damping force during forward rotation and a damping force during reverse rotation is good.

Optionally, a material of the elastomer 231 is SUS 301EH. A proper elastic arm is designed to provide an appropriate elastic force for the button 300 to rebound, and improve an anti-fatigue capability of the button 300.

Optionally, the elastomer 231 is in a form of single elastic arm, so that less space is used and a long-term corrosion risk can be reduced. The elastomer 231 has a sufficient arm length, so that the elastomer 231 is prevented from generating the plastic deformation in a long-term pressing process.

Optionally, the button switch 230 may be a dome (dome) switch.

The rotation detection sensor 240 may be any appropriate type of sensor that is configured to detect rotation of the second button lever 330, for example, a laser sensor or a Hall sensor. The rotation detection sensor 240 is located on a flexible printed circuit (flexible printed circuit, FPC), and is fastened to the mounting holder 220 by using the heat stake.

In some cases, an outer surface of the inner end of the second button lever 330 may be made into a rough surface. In other words, a peripheral part of the second button lever 330 has specific roughness, to assist detection performed by the rotation detection sensor 240.

Optionally, to improve detection precision, a hex nut may be sleeved at the inner end of the second button lever 330, and light emitted by the laser sensor is reflected back by using the hex nut. When the button rotates, the laser sensor can detect the rotation angle by using different reflection conditions.

As shown in FIG. 4 to FIG. 7, a positioning ring slot 331b is provided on a periphery of the second button lever 330, the second button lever 330 is embedded into the second button hole 210 through an elastic rubber ring 331c, and the elastic rubber ring 331c is sleeved on the periphery of the second button lever 330 and is located in the positioning ring slot 331b. Through the foregoing disposition, the second button lever 330 can be limited to a specific extent, the second button lever 330 is prevented from extending outward to the first button hole 111 under an action of the elastomer 231, and the disposition of the elastic rubber ring 331c can further have waterproof and dustproof function. A plurality of elastic rubber rings 331c and a plurality of positioning ring slots 331b may be disposed in a one-to-one correspondence. The elastic rubber ring 331c may be an O-ring, for example, may be a rubber ring.

Further, as shown in FIG. 3, the watch core 200 includes the watch core case 250, the second button hole 210 is provided on the watch core case 250, and a positioning convex ring 331d is further convexly disposed on a periphery of the inner end of the second button lever 330. The positioning convex ring 331d is located on an inner side of the watch core case 250, and can limit outward extension of the second button lever 330, to be specific, prevent the second button lever 330 from extending outward to the first button hole 111 or prevent the second button lever 330 from falling out from the second button hole 210.

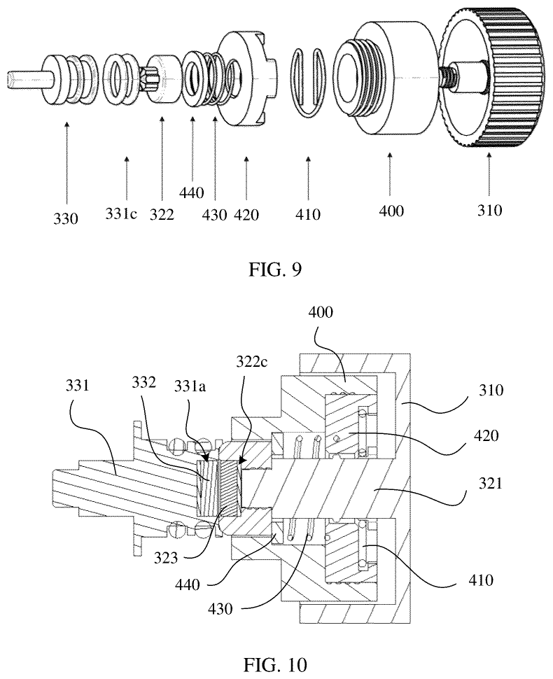

FIG. 8 is a diagram of an assembling structure of another example of a button 300 of a smartwatch according to an embodiment of this application. FIG. 9 is an exploded view of the structure shown in FIG. 8. As shown in FIG. 8 and FIG. 9, to assist detection performed by a rotation detection sensor 240 and improve detection precision, a hex nut 340 is sleeved on an inner end of a second button lever 330, for example, the hex nut 340 and the second button lever 330 are fastened through a thread connection, and an outer surface of the hex nut 340 may be made into a rough surface, for example, uneven texture is provided on the outer surface. Light emitted by the rotation detection sensor 240 (for example, a laser sensor) is reflected back by using the hex nut 340. When the button rotates, the rotation detection sensor 240 can detect a rotation angle by using different reflection conditions.

As shown in FIG. 4 to FIG. 7, the smartwatch provided in this embodiment of this application further includes a crown tube 400. The crown tube 400 is sleeved on a periphery of a first button lever 320, and an inner end is fixedly inserted into a first button hole 111. The crown tube 400 may be fastened to an outer surface of a watch frame 110 through at least one of riveting, screwing, bonding, or welding, and the inner end extends into the first button hole 111. For example, the crown tube 400 is fastened to the watch frame 110 by using a thread. After being screwed into the first button hole 111, the crown tube 400 is spot welded to the watch frame 110, to prevent the crown tube 400 from being unscrewed in reverse.

As shown in FIG. 5 to FIG. 7, the first button lever 320 includes a first lever body 321 and a connecting block 322. One end of the first lever body 321 is fastened to a button cap 310, for example, the first lever body 321 and the button cap 310 are integrated. The other end of the first lever body 321 is fixedly sleeved with the connecting block 322, and the connecting block 322 slides and penetrates through the inner end of the crown tube 400. The button 300 can perform rotation or pressing operation in the crown tube 400. Stability of rotational movement or extension movement of the button 300 can be improved by disposing the connecting block 322 that slides and penetrates through the inner end of the crown tube 400.

Further, as shown in FIG. 5 to FIG. 7, a fastening slot 322b with an internal thread is provided on a rear end face of the connecting block 322, and an external thread that fits the internal thread is provided on an outer surface of an inner end of the first lever body 321. The connecting block 322 is fastened to the first lever body 321 through the fastening slot 322b. Through the foregoing disposition, a reliable connection between the connecting block 322 and the first lever body 321 can be conveniently and efficiently implemented.

Further, as shown in FIG. 5 to FIG. 7, the smartwatch provided in this embodiment of this application further includes a spring bar 410 and a spring bar holder 420. The spring bar holder 420 is fastened to an inside of the crown tube 400 and sleeved on a periphery of the first lever body 321. The spring bar 410 is assembled on the spring bar holder 420 through interference. The spring bar 410 is configured to provide an elastic clamping force for the first lever body 321, so that the button 300 can be better positioned. The spring bar 410 clamps the first lever body 321, so that a feeling of damping can be further provided to a user during rotation.

As shown in FIG. 5 to FIG. 7, the spring bar holder 420 is of a disk-shaped structure and is connected to the inside of the crown tube 400 through the thread. A through hole for the first lever body 321 to penetrate is provided on a middle part of the spring bar holder 420. A hole diameter of the through hole is slightly greater than an outer diameter of the first lever body 321, to ensure that the first lever body 321 can smoothly rotate.

The button 300 in this embodiment of this application has a working state and a detached state. It is considered that the button 300 has far more working scenarios than detaching scenarios. To facilitate use by the user, the working state may be a default state of the button 300. To be specific, the first button lever 320 remains engaged with the second button lever 330 under no external force. In this case, the user may directly adjust the smartwatch by using the button 300.

Further, the smartwatch further includes an elastic component. An elastic force of the elastic component enables the first button lever 320 and the second button lever 330 to remain engaged with each other. In other words, the elastic component enables the button 300 to elastically remain the working state. When the user needs to detach a watch core 200, the user may pull the first button lever 320 outward by overcoming the elastic force of the elastic component by using the button cap 310, so that the button 300 is switched from the working state to the detached state.

In a possible implementation, as shown in FIG. 5 to FIG. 7, the smartwatch provided in this embodiment of this application further includes a spring 430 and a gasket 440. The spring 430 and the gasket 440 are both sleeved on the first lever body 321 and are elastically clamped between the connecting block 322 and the spring bar holder 420 (that is, located on a side that is of the spring bar holder 420 and that face away from the spring bar 410). The spring 430 provides an elastic force to the connecting block 322 through the gasket 440. One end of the spring 430 abuts against the spring bar holder 420, and the other end abuts against a rear end face of the connecting block 322 through the gasket 440, so that the first button lever 320 can be tightly pressed on the second button lever 330, that is, the button 300 is enabled to remain the working state.

Through the foregoing disposition, when the watch core 200 is mounted in alignment, the connecting block 322 can be quickly and accurately butted with the second button lever 330 under an action of the spring 430 in the crown tube 400, so that a button function and a limiting function are implemented, the button 300 can reliably remain the working state, and the use by the user is facilitated. In addition, button levers are not rigidly connected due to existence of the spring 430, so that the button 300 can be prevented from being damaged due to forgetting to pull the button cap 310 (crown) when the watch core 200 is detached, which has a cushioning function.

When the button 300 is in the working state, the first button lever 320 and the second button lever 330 are engaged with each other, and the second button lever 330 can transfer pressure or torque from the button cap 310. A manner of engaging between the first button lever 320 and the second button lever 330 is not specifically limited in this application, provided that a pressing force and the torque can be transferred. For example, the first button lever 320 and the second button lever 330 may jointly form a “clutch”, which can implement engaging and separating, and can further implement power transmission or interruption, to help the user to take the watch core 200 out of the watch frame 111 when power interruption is implemented.

As shown in FIG. 5 to FIG. 7, when the button 300 is in the working state, the first button lever 320 and the second button lever 330 are plug-connected and cooperate with each other. One of the first button lever 320 and the second button lever 330 may be provided with a structure such as a plug, an insertion block, an insertion stake, or an insertion pin, and the other one may be provided with an insertion slot or an insertion jack that fits with the structure.

Further, in this embodiment of this application, a positioning plug 322a is disposed on a front end face of the connecting block 322, so that the connecting block 322 is generally of an inverted T-shaped structure, and a second positioning slot 331a for the positioning plug 322a to be inserted into is disposed on an end face of the second button lever 330. In a free state (that is, in the working state), under the action of the spring 430, the positioning plug 322a is inserted into the second positioning slot 331a. A cross-sectional shape of the positioning plug 322a is a non-standard circle, for example, may be a triangle or a hexagon. In this case, a pressing force and torque can be both transferred between the first button lever 320 and the second button lever 330, and the first button lever 320 can drive the second button lever 330 to synchronously rotate.

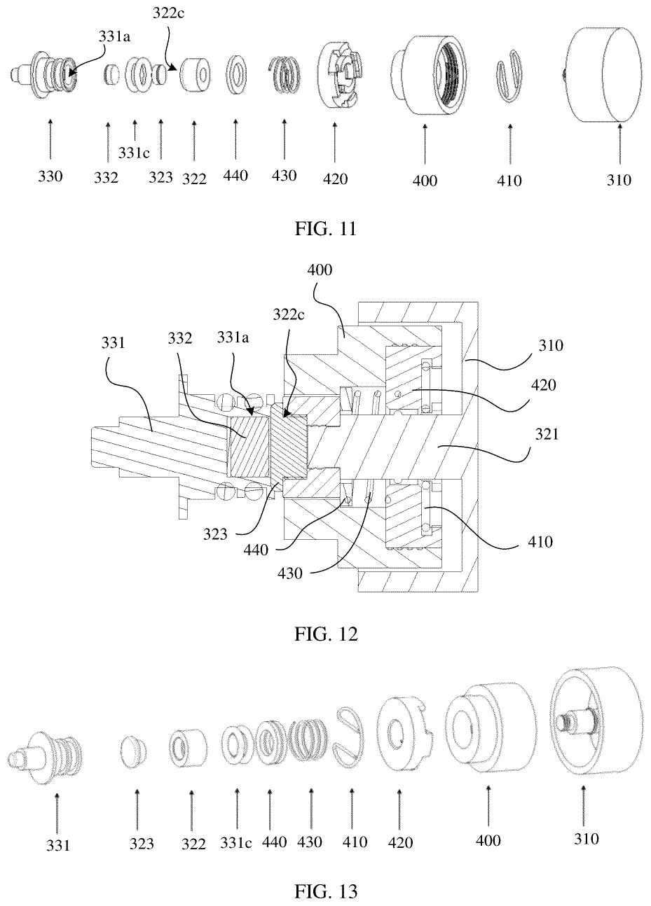

In another implementation, the first button lever 320 and the second button lever 330 may alternatively be engaged with each other in another manner. FIG. 10 is a diagram of an assembling structure of still another example of a button 300 of a smartwatch according to an embodiment of this application. FIG. 11 is an exploded view of the structure shown in FIG. 10.

As shown in FIG. 10 and FIG. 11, when a button 300 is in a working state, an end face of a first button lever 320 abuts against an end face of a second button lever 330 to generate a friction force, and torque is transferred by using the friction force. To enable the friction force large enough, the end face of the first button lever 320 and the end face of the second button lever 330 may be disposed to be relatively rough. The friction force may be, for example, stiction.

Further, the smartwatch provided in this embodiment of this application further includes a magnetic component. The magnetic component is configured to generate a magnetic attraction force to increase pressure between the end face of the first button lever 320 and the end face of the second button lever 330, so that the friction force between the end face of the first button lever 320 and the end face of the second button lever 330 can be increased. This helps implement smooth transfer of torque.

As shown in FIG. 10 and FIG. 11, in this embodiment of this application, a first positioning slot 322c is disposed on an end face of a connecting block 322, and the first button lever 320 further includes a first magnetic component 323 that is fastened in the first positioning slot 322c (for example, through adhesive bonding). The second button lever 330 includes a second lever body 331 and a second magnetic component 332, and the second magnetic component 332 is fastened in a second positioning slot 331a that is disposed on an end face of the second lever body 331. There is a magnetic attraction force between the first magnetic component 323 and the second magnetic component 332. When the button 300 is in the working state, the first magnetic component 323 and the second magnetic component 332 are attached to each other. Bonding faces of the first magnetic component 323 and the second magnetic component 332 are both rough surfaces. Under effect of the magnetic attraction force, there is sufficient positive pressure between the first magnetic component 323 and the second magnetic component 332. In this case, that a sufficient friction force is generated between the two contact end faces can be ensured, and torque from a button cap 310 can be smoothly transferred to the second magnetic component 332.

Optionally, the first magnetic component 323 and the second magnetic component 332 may be both magnets, and the first magnetic component 323 and the second magnetic component 332 remain attracting each other.

Optionally, one of the first magnetic component 323 and the second magnetic component 332 is a magnet, and the other is a magnetic metal material such as iron or nickel.

Optionally, in another implementation, smooth transfer of the torque may alternatively be implemented between the first button lever 320 and the second button lever 330 through adhesive bonding or the like. A user can separate the first button lever 320 from the second button lever 330 from an adhesive bonding state by applying a sufficient force to the button cap 310.

FIG. 12 is a diagram of an assembling structure of still another example of a button 300 of a smartwatch according to an embodiment of this application. FIG. 13 is an exploded view of the structure shown in FIG. 12. As shown in FIG. 12 and FIG. 13, compared with the foregoing embodiment shown in FIG. 10 and FIG. 11, in this embodiment of this application, a front end of a first magnetic component 323 extends from a first positioning slot 322c, and extends along an end face of a connecting block 322 to surrounding edges, so that the first magnetic component 323 has a larger contact surface. The contact surface is not only attached to a second magnetic component 332, but also attached to an end face of a second button lever 330. Therefore, a larger friction force can be generated, and it is ensured that torque is smoothly transferred.

Further, in this embodiment, friction positions such as the first magnetic component 323, the second magnetic component 332, the end face of the second button lever 330, a gasket 440, and a front end of a hex nut are all plated with a diamond-like carbon (diamond-like carbon, DLC) film coating with self-lubrication, high hardness, and high wear resistance. An inner end face (a contact surface with an elastomer 231) of the second button lever 330 and a surface of the elastomer 231 are both plated with the DLC coating, so that rotation durability of the second button lever 330 and the elastomer 231 is improved, and lubricating performance of the DLC coating can also reduce rotation damping of the button. A surface of a spring bar 410 is also plated with the DLC coating with self-lubrication, high hardness, and high wear resistance, to ensure that the first button lever 320 does not fail, during long-term rotation, due to abrasion of the spring bar 410.

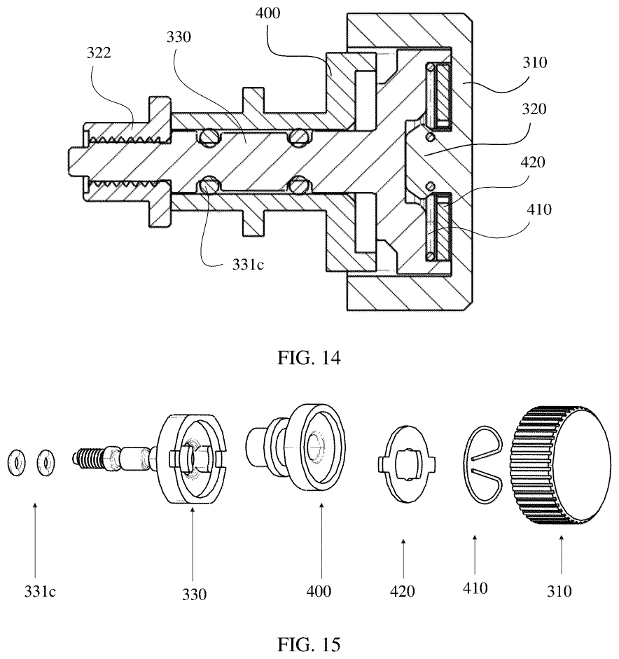

FIG. 14 is a diagram of an assembling structure of still another example of a button 300 of a smartwatch according to an embodiment of this application. FIG. 15 is an exploded view of the structure shown in FIG. 14.

As shown in FIG. 14 and FIG. 15, compared with the foregoing embodiments, in this embodiment, a crown tube 400 is sleeved on a periphery of a second button lever 330, and an outer end of the second button lever 330 penetrates from a surface to an outside of the watch, and is located in the crown tube 400. An outer end face of the second button lever 330 is provided with a clamping hole and the foregoing spring bar 410, and a first button lever 320 is elastically clamped (detachably connected) to the clamping hole by using the spring bar 410. In this case, a user can take a button cap 310 out of the crown tube 400 by pulling the button cap 310, to help the user change the button cap. The user may customize the button cap 310, and can laser etch different figures, text, or the like on the button cap 310, to meet a requirement for personalized customization of the user.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A smartwatch, comprising:
a watch frame, wherein a first button hole is provided on the watch frame, a watch core is disposed in the watch frame, and a second button hole is provided on the watch core opposite to the first button hole; and
a button, comprising a button cap, a first button lever, and a second button lever, wherein the button cap is connected to the first button lever, the first button lever is disposed in the first button hole, and the second button lever is disposed in the second button hole,
wherein the button is configured to enter a working state or a detached state by adjusting a position of the first button lever through the button cap, and
wherein when the button is in the working state, the first button lever and the second button lever are engaged with each other, and the second button lever is capable of transferring pressure or torque from the button cap, or when the button is in the detached state, the first button lever and the second button lever are separated from each other, and the watch core is capable of being taken out of the watch frame.

2. The smartwatch according to claim 1, wherein when the button is in the working state, an end face of the first button lever abuts against an end face of the second button lever to generate a friction force, and the torque is transferred from the button cap through the friction force.

3. The smartwatch according to claim 2, wherein the smartwatch further comprises:
a crown tube, wherein the crown tube is sleeved on a periphery of the first button lever, and an inner end of the crown tube is fixedly inserted into the first button hole, wherein
the first button lever comprises a first lever body and a connecting block, a first end of the first lever body is fastened to the button cap, a second end of the first lever body is fixedly sleeved with the connecting block, and the connecting block is configured to slide and penetrate through the inner end of the crown tube.

4. The smartwatch according to claim 2, wherein the watch core comprises:
a mounting holder;
a button switch, mounted on the mounting holder and configured to be pressed by the second button lever, wherein the button switch comprises an elastomer configured to reset the second button lever; and
a rotation detection sensor, mounted on the mounting holder and configured to detect a rotation angle of the second button lever.

5. The smartwatch according to claim 2, wherein the smartwatch further comprises magnetic components, and the magnetic components are configured to generate a magnetic attraction force to increase pressure between the end face of the first button lever and the end face of the second button lever.

6. The smartwatch according to claim 5, wherein the smartwatch further comprises:
a crown tube, wherein the crown tube is sleeved on a periphery of the first button lever, and an inner end of the crown tube is fixedly inserted into the first button hole, wherein
the first button lever comprises a first lever body and a connecting block, a first end of the first lever body is fastened to the button cap, a second end of the first lever body is fixedly sleeved with the connecting block, and the connecting block is configured to slide and penetrate through the inner end of the crown tube.

7. The smartwatch according to claim 5, wherein the watch core comprises:
a mounting holder;
a button switch, mounted on the mounting holder and configured to be pressed by the second button lever, wherein the button switch comprises an elastomer configured to reset the second button lever; and
a rotation detection sensor, mounted on the mounting holder and configured to detect a rotation angle of the second button lever.

8. The smartwatch according to claim 1, wherein when the button is in the working state, the first button lever and the second button lever are plug-connected and cooperate with each other.

9. The smartwatch according to claim 8, wherein the watch core comprises:
a mounting holder;
a button switch, mounted on the mounting holder and configured to be pressed by the second button lever, wherein the button switch comprises an elastomer configured to reset the second button lever; and
a rotation detection sensor, mounted on the mounting holder and configured to detect a rotation angle of the second button lever.

10. The smartwatch according to claim 8, wherein the smartwatch further comprises:
a crown tube, wherein the crown tube is sleeved on a periphery of the first button lever, and an inner end of the crown tube is fixedly inserted into the first button hole, wherein the first button lever comprises a first lever body and a connecting block, a first end of the first lever body is fastened to the button cap, a second end of the first lever body is fixedly sleeved with the connecting block, and the connecting block is configured to slide and penetrate through the inner end of the crown tube.

11. The smartwatch according to claim 10, wherein a positioning plug is disposed on an end face of the connecting block, and a second positioning slot for the positioning plug to be inserted into is disposed on the end face of the second button lever.

12. The smartwatch according to claim 10, wherein:
a first positioning slot is disposed on an end face of the connecting block, and the first button lever further comprises a first magnetic component that is located in the first positioning slot;
the second button lever comprises a second lever body and a second magnetic component, and the second magnetic component is disposed in a second positioning slot that is disposed on an end face of the second lever body; and
when the button is in the working state, the first magnetic component and the second magnetic component are attached to each other by a magnetic attraction force between the first magnetic component and the second magnetic component.

13. The smartwatch according to claim 10, wherein the smartwatch further comprises:
a spring bar holder, fastened to an inside of the crown tube and sleeved on a periphery of the first lever body; and
a spring bar, disposed on the spring bar holder, wherein the spring bar is configured to provide an elastic clamping force for the first lever body.

14. The smartwatch according to claim 13, wherein the smartwatch further comprises:
a spring and a gasket, both sleeved on the first lever body and clamped between the connecting block and the spring bar holder, wherein the spring is configured to provide an elastic force for the connecting block through the gasket, to keep the button in the working state.

15. The smartwatch according to claim 14, wherein the spring bar holder is a disk-shaped structure and is connected to the inside of the crown tube through a thread, and the spring bar and the spring are located on opposite sides of the spring bar holder.

16. The smartwatch according to claim 10, wherein a fastening slot with an internal thread is provided on a rear end face of the connecting block, and the connecting block is fastened to the first lever body through the fastening slot.

17. The smartwatch according to claim 10, wherein the crown tube is fastened in the first button hole through bonding, screwing, welding, or riveting.

18. The smartwatch according to claim 1, wherein the second button lever is embedded into the second button hole by an elastic rubber ring, and the elastic rubber ring is sleeved on a periphery of the second button lever and is located in a positioning ring slot.

19. The smartwatch according to claim 1, wherein the watch core comprises:
a mounting holder;
a button switch, mounted on the mounting holder and configured to be pressed by the second button lever, wherein the button switch comprises an elastomer configured to reset the second button lever; and
a rotation detection sensor, mounted on the mounting holder and configured to detect a rotation angle of the second button lever.

20. The smartwatch according to claim 1, wherein the watch core comprises a display and a watch core case, the display is fastened on the watch core case, and the second button hole is provided on the watch core case.
